(19) United States
(12) Patent Application Publication
(10) Pub. No.: US 2009/0004991 A1
(43) Pub. Date: Jan. 1, 2009

(54) RECEIVING APPARATUS WITH ENHANCED ISOLATION

(75) Inventor: Shing-Yeu Juang, Taoyuan Hsien (TW)

Correspondence Address: ROSENBERG, KLEIN & LEE, 3458 ELLICOTT CENTER DRIVE-SUITE 101, ELLICOTT CITY, MD, 21043, US

(73) Assignee: SPEED TECH CORP., Taoyuan Hsien (TW)

(21) Appl. No.: 11/691,204

(22) Filed: Mar. 26, 2007

(51) Int. Cl. H04B 1/10

(52) U.S. Cl. 455/307

(57) ABSTRACT

A receiving apparatus with enhanced isolation is provided. The receiving apparatus includes a wireless detection unit, a switch connector and a receiver. The wireless detection unit includes an internal antenna and an amplifier. When the receiving apparatus is coupled to an external antenna through the switch connector, the isolation is increased through disabling the amplifier between the external antenna and the internal antenna. Therefore, the effect of co-channel interference and multi-path interference on the receiver is effectively reduced.

### BACKGROUND OF THE INVENTION

1. Field of the Invention

The present invention relates to a receiving apparatus with enhanced isolation, and more particularly to a receiving apparatus that enhance its isolation through enabling or disabling an amplifier.

2. Description of Related Art

With government sponsorship and intensive promotion of the ‘digitizing Taiwan scheme’ in recent years, the environment for developing digital television is gradually mature. Simply said, digital television is a new type of broadcasting technique that converts the analog signal transmitted from a television station into digital form for transmission. Compared to a conventional analog television, the advantages of a digital television include multiple-channel broadcasting, interactive, mobile reception and non-synchronous operation.

To achieve the merit of mobile reception, digital television relies on a wireless reception method to transmit digital television signals. A receiving apparatus for receiving digital television signals is shown in FIG. 1. As shown in FIG. 1, a conventional receiving apparatus 100 includes an internal antenna 110, a switch connector 120 and a receiver 130. When the pre-installed connecting terminal 121 of the switch connector 120 is not coupled to any external device, the signal connecting terminal 123 of the switch connector 120 is coupled to a fixed connecting terminal 122. Thus, the receiver 130 uses the internal antenna 110 to receive digital television signals.

On the other hand, the internal antenna 110 of the conventional receiving apparatus 100 may not provide a sufficient antenna gain to maintain the quality of digital television signals due to a variation in the external environment. Considering the quality of the digital television signal under such circumstances, the conventional receiving apparatus 100 may be coupled to an external antenna 200 through a pre-installed connecting terminal 121 of the switch connector 120 as shown in FIG. 2. Since the signal connecting terminal 123 of the switch connector 120 is coupled to the pre-installed connecting terminal 121, the receiver 130 uses the external antenna 200 to receive the digital television signals.

However, when the conventional receiving apparatus 100 is coupled to an external antenna 200, the digital television signals received by the internal antenna 110 may also be coupled to the receiver 130 due to poor isolation of the switch connector 120. If the receiver 130 simultaneously receives digital television signals from the internal antenna 110 and the external antenna 200, the so-called co-channel interference and multi-path interference are formed.

### SUMMARY OF THE INVENTION

Accordingly, the present invention is directed to a receiving apparatus with enhanced isolation that utilizes the enablement or disablement of an amplifier to enhance the signal from an internal antenna or suppress co-channel interference and multi-path interference.

To achieve these and other advantages, as embodied and broadly described herein, the invention provides a receiving apparatus capable of enhancing isolation. The receiving apparatus includes a wireless detection unit, a switch connector and a receiver. A fixed connecting terminal of the switch connector is coupled to the wireless detection unit, and a signal connecting terminal of the switch connector is coupled to the receiver. Furthermore, a pre-installed connecting terminal is used for providing a connective path to an external antenna. The wireless detection unit is used for detecting electromagnetic signals in space, and receiving and enhancing the received signals. The switch connector is used for coupling the signal connecting terminal to the pre-installed connecting terminal or the fixed connecting terminal according to the coupling state of the pre-installed connecting terminal.

When the pre-installed connecting terminal is not coupled to any external device, the signal connecting terminal of the switch connector is coupled to the fixed connecting terminal. Thus, the receiver enables the wireless detection unit through the fixed connecting terminal to receive signal from the wireless detection unit. Conversely, when the pre-installed terminal is coupled to an external antenna, for example, the receiver receives the signal from the external antenna through the pre-installed connecting terminal.

In an embodiment of the present invention, the wireless detection unit includes an internal antenna and an amplifier. The internal antenna is used for detecting and receiving electromagnetic signal in space. The amplifier is used for amplifying the signal received by the internal antenna.

It should be noted that the receiver transmits a first voltage through the switch connector. When the signal connecting terminal and the fixed connecting terminal are coupled, the amplifier operates in the first voltage. Conversely, the first voltage is transmitted to the external antenna.

In addition, the receiving apparatus with enhanced isolation may be applied to a digital television system. Therefore, the signal received by the internal antenna is a digital television antenna, and the signal received by the external antenna is also a digital television antenna.

In brief, the present invention utilizes the switch connector to simultaneously transmit the signal received by the receiving apparatus and the first voltage mechanism so that the amplifier can be activated at appropriate time. Hence, when the receiving apparatus uses the internal antenna to receive signal, the amplifier is enabled to enhance the signal received by the internal antenna. Conversely, when the receiving apparatus utilizes the external antenna to receive the signal, the amplifier is disabled so as to increase the isolation between the external antenna and the internal antenna. Consequently, the effects of co-channel interference and multi-path interference on the receiver are minimized.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a conventional receiving apparatus.

FIG. 2 is a schematic diagram showing an application of the conventional receiving apparatus in FIG. 1.

FIG. 3 is a schematic diagram of a receiving apparatus with enhanced isolation according to an embodiment of the present invention.

FIG. 4 is a schematic diagram showing an application of the receiving apparatus in FIG. 3.

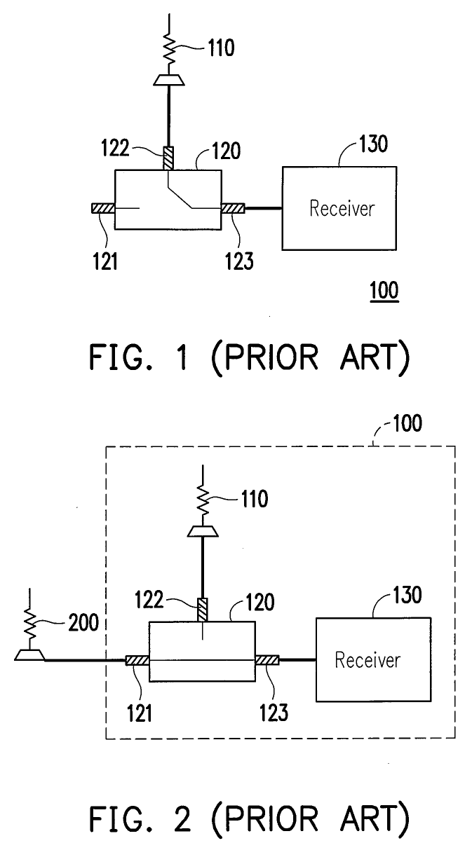

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

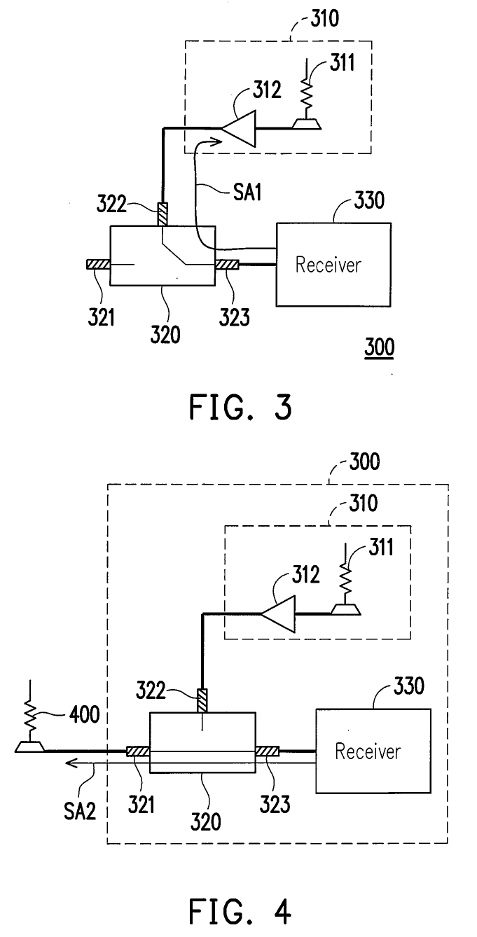

FIG. 3 is a schematic diagram of a receiving apparatus with enhanced isolation according to an embodiment of the present invention. As shown in FIG. 3, the receiving apparatus 300 includes a wireless detection unit 310, a switch connector 320 and a receiver 330. The switch connector 320 has a pre-installed connecting terminal 321, a fixed connecting terminal 322 and a signal connecting terminal 323. Furthermore, the pre-installed connecting terminal 321 is used for providing a connecting path to an external antenna (not shown). The fixed connecting terminal 322 is coupled to the wireless detection unit 310. The signal connecting terminal 323 is coupled to the receiver 330.

More specifically, the wireless detection unit 310 includes an internal antenna 311 and an amplifier 312. The amplifier 312 is coupled to the internal antenna 311 and the fixed connecting terminal 322.

During operation, the switch connector 320 is used for coupling the signal connecting terminal 323 to the pre-installed connecting terminal 321 or the fixed connecting terminal 322 according to the coupling state of the pre-installed connecting terminal 321. Therefore, the receiver 330 may receive signal from the pre-installed connecting terminal 321 or the fixed connecting terminal 322 through the switch connector 320. Correspondingly, the receiver 330 may transmit a first voltage to the pre-installed connecting terminal 321 or the fixed connecting terminal 322 through the switch connector 320.

As shown in FIG. 3, when the pre-installed connecting terminal 321 is not coupled to an external device, the signal connecting terminal 323 and the fixed connecting terminal 322 of the switch connector 320 are coupled together. Thus, the receiver 330 is able to transmit a first voltage to the wireless detection unit 310 through the fixed connecting terminal 322 as indicated by the arrow symbol SA1, and the first voltage is used to drive the wireless detection unit 310. Because the first voltage enables the amplifier 312, the signal detected and received by the internal antenna 311 may be enhanced through the amplifier 312 so that the receiver 330 is able to receive the signal from the internal antenna 311. In other words, when the pre-installed connecting terminal 321 is not connected to any external device, the receiver 330 provides the first voltage through the fixed connecting terminal 322 to enable the wireless detection unit 310 so as to receive signal from the wireless detection unit 310.

On the other hand, when the pre-installed connecting terminal 321 is coupled to an external antenna 400 as shown in FIG. 4, the signal connecting terminal 323 and the pre-installed connecting terminal 321 of the switch connector 320 are coupled together. Thus, the receiver 330 is able to transmit a first voltage to the external antenna 400 through the switch connector 320 as indicated by the arrow symbol SA2. Anyone skilled in the art may notice that the first voltage is a DC voltage and hence will not affect the operation of the external antenna 400. Correspondingly, the signal connecting terminal 323 and the pre-installed connecting terminal 321 form a connecting path such that the receiver 330 is able to receive signal from the external antenna 400.

It should be noted that, when the first voltage is transmitted to the external antenna 400, the amplifier 312 is in a disabled state. The internal resistance of the amplifier 312 is able to increase a barrier for transmitting signal, which is received by the internal antenna 311 through the fixed connecting terminal 322, to the signal connecting terminal 323. This means that the amplifier 312 has the ability to isolate the signal received by the internal antenna 311. In other words, when the pre-installed connecting terminal 321 is coupled to an external antenna 400, the isolation between the internal antenna 311 and the external antenna 400 is increased after the amplifier 312 is disabled. Correspondingly, the probability of the signal received by the internal antenna 311 being coupled to the receiver 330 is significantly reduced. As a result, the receiver 330 may prevent the internal antenna 311 from causing co-channel interference and multi-path interference.

Furthermore, the amplifier 312 in the present embodiment includes a low noise amplifier. However, anyone skilled in the art may notice that there are different types of amplifier structures. Therefore, different types of amplifiers can be used as the amplifier 312. In addition, the receiving apparatus 300 in the present embodiment is suitable for a digital television system. Hence, the signal received by the internal antenna 311 is a digital television signal, and the signal received by the external antenna 400 is also a digital television signal.

In summary, the present invention utilizes the switch connector to simultaneously transmit the signal received by the receiving apparatus and the first voltage so that the amplifier can be enabled or disabled at appropriate time. Hence, when the receiving apparatus utilizes the external antenna to receive the signal, co-channel interference and multi-path interference between the internal antenna and the external antenna are efficiently suppressed.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A receiving apparatus with enhanced isolation, comprising:
a wireless detection unit for detecting electromagnetic signal in space, and receiving and enhancing the detected signal;
a switch connector having a pre-installed connecting terminal, a fixed connecting terminal and a signal connecting terminal, wherein the pre-installed connecting terminal provides a connecting path to an external antenna, the fixed connecting terminal is coupled to the wireless detection unit, and the signal connecting terminal is coupled to the pre-installed connecting terminal or the fixed connecting terminal according to a coupling state of the pre-installed connection terminal; and
a receiver, coupled to the signal connecting terminal, wherein the receiver receives signal from the external antenna through the pre-installed connecting terminal when the pre-installed connecting terminal is coupled to the external antenna, and conversely, the receiver enables the wireless detection unit through the fixed connecting terminal and receives signal from the wireless detection unit.

2. The receiving apparatus of claim 1, wherein the wireless detection unit comprises:
an internal antenna for detecting and receiving electromagnetic signal in space; and
an amplifier, coupled to the internal antenna and the fixed connecting terminal for enhancing the signal received by the internal antenna.

3. The receiving apparatus of claim 2, wherein the receiver transmits a first voltage through the switch connector such that the amplifier operates in the first voltage when the signal connecting terminal and the fixed connecting terminal are coupled, and otherwise, the first voltage is transmitted to the external antenna.

4. The receiving apparatus of claim 1, wherein the receiver transmits a first voltage through the switch connector and the first voltage is used for driving the wireless detection unit.

5. The receiving apparatus of claim 1, wherein the amplifier comprises a low noise amplifier.

6. The receiving apparatus of claim 1, wherein the signal received by the internal antenna is a digital television signal.

7. The receiving apparatus of claim 1, wherein the signal received by the external antenna is a digital television signal.
